(19) United States
(12) Patent Application Publication
(10) Pub. No.: US 2012/0180125 A1
(43) Pub. Date: Jul. 12, 2012

(54) METHOD AND SYSTEM FOR PREVENTING DOMAIN NAME SYSTEM CACHE POISONING ATTACKS

(75) Inventors: Hung-Min Sun, Hsinchu (TW); Jain-Ming Jeng, Hsinchu (TW)

(73) Assignee: NATIONAL TSING HUA UNIVERSITY, Hsinchu (TW)

(21) Appl. No.: 13/028,478

(22) Filed: Feb. 16, 2011

(30) Foreign Application Priority Data
Jan. 7, 2011 (TW) 10010062

(51) Int. Cl. G06F 21/00

(52) U.S. Cl. 726/22

(57) ABSTRACT

A method for preventing domain name system cache poisoning attacks comprises steps of inputting a domain name by an internet application program of an Internet communication device, determining in which area the Internet communication device is located, randomly selecting at least two domain name system resolvers of the area, retrieving at least one Internet protocol address from the domain name system resolvers and evaluating the Internet protocol addresses to generate at least one security score, selecting a trustworthy Internet protocol address based on the security scores, comparing the security score of the selected Internet protocol address with a predetermined security score threshold, and sending the trustworthy Internet protocol address to the Internet application program of the Internet communication device when the security score is greater than the security score threshold. A system for preventing domain name system cache poisoning attacks comprises an Internet communication device and an optional proxy server.

### FIELD OF THE INVENTION

The present invention is a method and a system for preventing domain name system cache poisoning attacks.

### BACKGROUND OF THE INVENTION

Domain name system cache poisoning attacks commonly transpire when websites are addressed and are attack techniques that allow an attacker to introduce forged DNS information into the cache of a caching name server. A “domain name system” (DNS) translates a domain name to an Internet protocol (IP) address and vice versa and comprises at least one caching name servers.

Each caching name server stores DNS query results and comprises a domain name record, a source port and a 16 bit cryptographic nonce and determines a period of time to hold the DNS query results. Conventional techniques to avoid DNS cache poisoning attacks include source port randomization.

Source port randomization for DNS requests, combined with use of cryptographically secure random numbers for selecting both the source port and the 16-bit cryptographic nonce can greatly reduce success of DNS cache attacks.

In 2008, Kaminsky discovered a fundamental flaw in the DNS itself. The fundamental flaw greatly enhanced cache attacks by introducing a nonce query method. Using the nonce query method, phishing has become wide-spread since victims have difficulty detecting such attacks. Hence, DNS cache poisoning is a serious threat to current DNS practices.

U.S. Patent No. 20100121981A1 discloses a method for preventing “DNS cache poisoning attacks” but cannot quantify security of IP addresses.

Accordingly, a new method and system are needed in the art to prevent DNS cache poisoning attacks, which can quantify security of IP addresses.

### SUMMARY OF THE INVENTION

The primary objective of the present invention is to prevent domain name system (DNS) cache poisoning attacks, quantify security of IP addresses and comprises a method and at least one system.

The method in accordance with the present invention comprises steps of inputting a domain name by an internet application program of an Internet communication device, determining in which area the Internet communication device is located, randomly selecting at least two domain name system resolvers of the area, retrieving at least one Internet protocol address from the domain name system resolvers and evaluating the Internet protocol addresses to generate at least one security score, selecting a trustworthy Internet protocol address based on the security scores, comparing the security score of the selected Internet protocol address with a predetermined security score threshold, and sending the trustworthy Internet protocol address to the Internet application program of the Internet communication device when the security score is greater than the security score threshold.

A first embodiment of a system in accordance with the present invention comprises an Internet communication device that comprises an Internet application program, an Internet protocol address analysis module, a location module and a domain name system resolver database.

A second embodiment of a system for preventing domain name system cache poisoning attacks in accordance with the present invention comprises an Internet communication device and a proxy server.

### BRIEF DESCRIPTION OF THE DRAWINGS

FIG. 1 is a flowchart of a first embodiment of a method for preventing domain name system cache poisoning attacks in accordance with the present invention;

FIG. 2 is a flowchart of a second embodiment of a method for preventing domain name system cache poisoning attacks in accordance with the present invention;

FIG. 3 is a functional block diagram of a first embodiment of a system in accordance with the present invention; and

FIG. 4 is a functional block diagram of a second embodiment of a system in accordance with the present invention.

### DETAILED DESCRIPTION OF THE PRESENT INVENTION

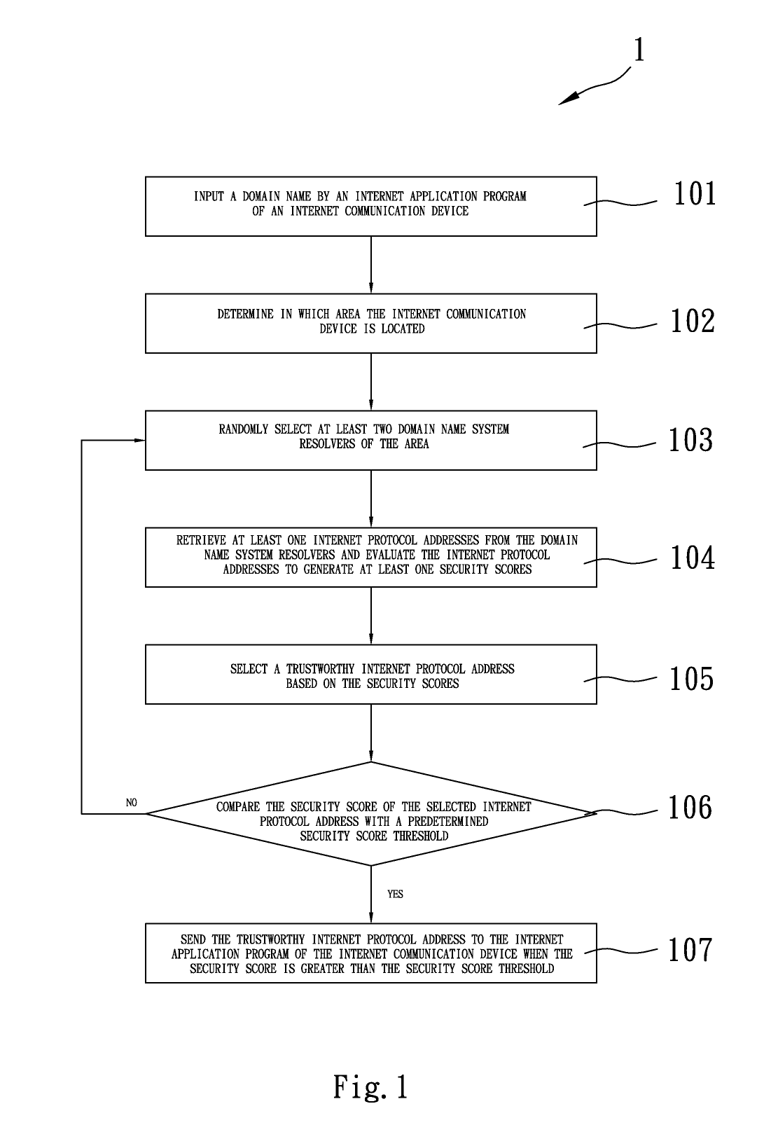

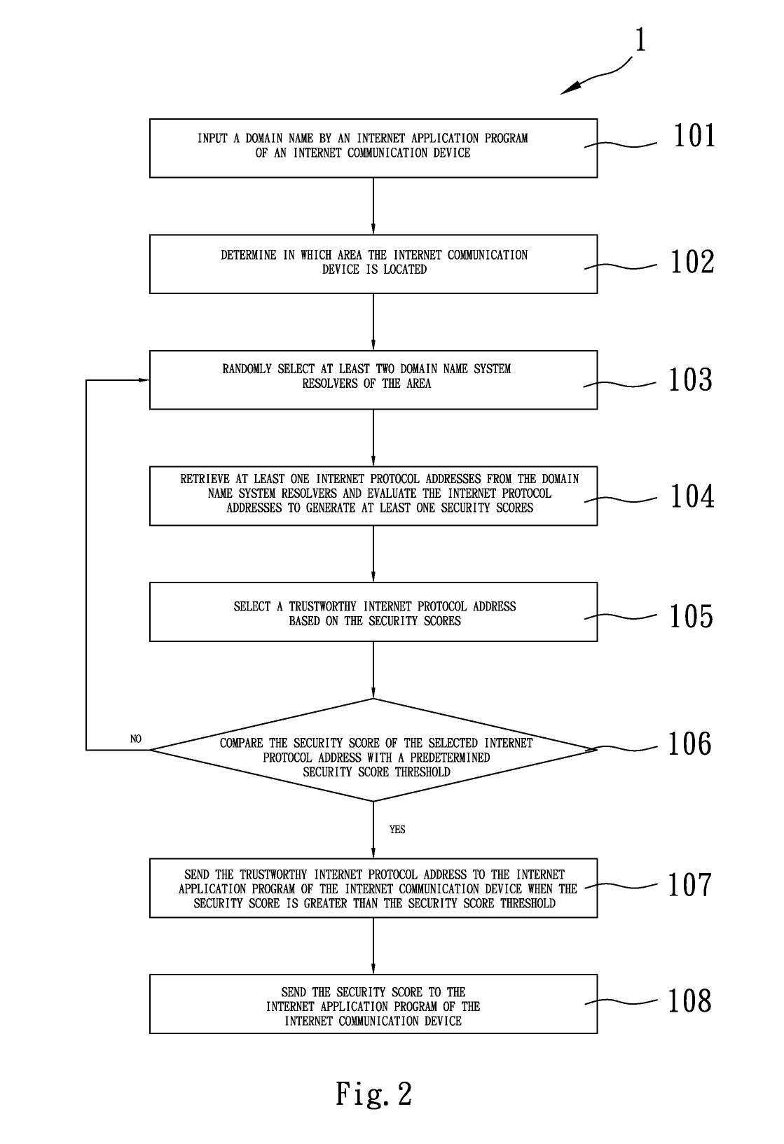

With reference to FIGS. 1 and 2, methods for preventing domain name system cache poisoning attacks (1) in accordance with the present invention can quantify security of Internet protocol addresses, are installed in domain name system client module of an operating system kernel or application program software and comprise steps of step 101 inputting a domain name, step 102 determining in which area an Internet communication device is located, step 103 randomly selecting at least two domain name system resolvers, step 104 retrieving at least one Internet protocol address from the domain name system resolver and evaluating the Internet protocol addresses to generate at least one security score, step 105 selecting a trustworthy Internet protocol address, step 106 comparing the security score of the selected Internet protocol address against a predetermined security score threshold, step 107 sending the trustworthy Internet protocol address to the Internet application program of the Internet communication device when the security score is greater than the security score threshold and optional step 108 of sending the security score to the Internet application program in an Internet communication device.

In step 101 of inputting a domain name, the domain name is input by an Internet application program of an Internet communication device.

Step 102 of determining in which area the Internet communication device is located may be achieved by a global positioning system, a time zone setting module, a language setting module or an Internet protocol address searching module of the Internet communication device.

In step 103 of randomly selecting at least two domain name system resolvers, each domain name system resolvers has a security weight that is set by security level and is of the area in which the Internet communication device is located.

Generating at least one security score in step 104 may be derived from products of a predetermined security level and an amount of the at least two domain name system resolvers. Retrieving at least one Internet protocol address and evaluating the Internet protocol addresses to generate at least one security scores may be accomplished simultaneously.

Step 105 of selecting a trustworthy Internet protocol address based on the security scores may be performed before retrieving all of the Internet protocol addresses.

Step 108 may be performed after step 107 of sending the trustworthy Internet protocol address to the Internet application program of the Internet communication device when the security score is greater than the security score threshold.

For example, the domain name system resolvers are categorized into level 1, level 2 and level 3, and the domain name system resolvers are weighted respectively at each level. The weight of level 1 is 1 and represents that the domain name system resolvers have part source port randomization. The weight of level 2 is 2 and represents that the domain name system resolvers have source port randomization and one source Internet protocol address. The weight of level 3 is 3 and represents that the domain name system resolvers have source port randomization and multiple source Internet protocol addresses.

The predetermined security score threshold is 20.

If step 104 retrieves three Internet protocol addresses, the addresses are a first Internet protocol address, a second Internet protocol address and a third Internet protocol address. The first Internet protocol address is retrieved from 5 level 1 domain name system resolvers, 4 level 2 domain name system resolvers and 3 level 3 domain name system resolvers. The security score of the first Internet protocol address equals:

1×5+2×4+3×3=22.

The second Internet protocol address is retrieved from 2 level 1 domain name system resolvers, 3 level 2 domain name system resolvers and 4 level 3 domain name system resolvers. The security score of the second Internet protocol address equals:

1×2+2×3+3×4=20.

The third Internet protocol address is retrieved from 4 level 1 domain name system resolvers, 3 level 2 domain name system resolvers and 5 level 3 domain name system resolvers. The security score of the third Internet protocol address equals:

1×4+2×3+3×5=25.

Consequently, the third Internet protocol address is a trustworthy Internet protocol address and is sent to the Internet application program of the Internet communication device because the security score of the third Internet protocol address is greater than the security score threshold.

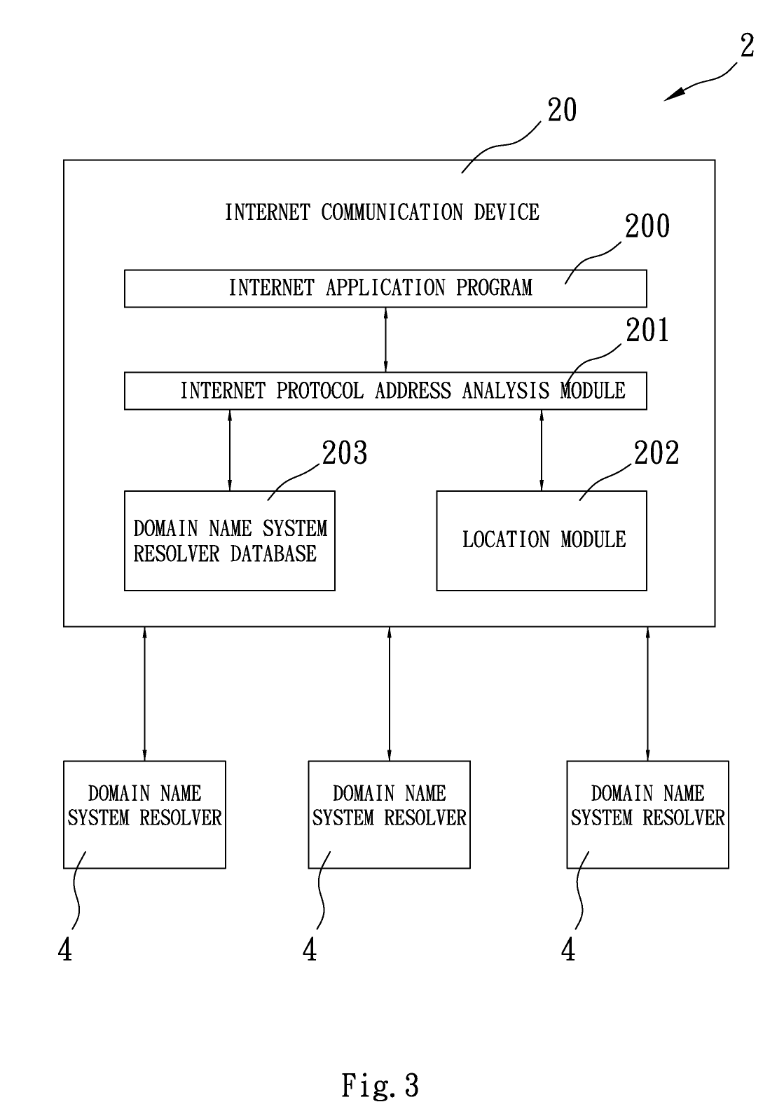

With reference to FIG. 3, a first embodiment of a system for preventing domain name system cache poisoning attacks (2) in accordance with the present invention quantifies security of the Internet protocol address and comprises an Internet communication device (20). The Internet communication device (20) comprises an Internet application program (200), an Internet protocol address analysis module (201), a location module (202) and a domain name system resolver database (203).

The Internet application program (200) connects to the Internet.

The Internet protocol address analysis module (201) is connected to the Internet application program (200), selects a trustworthy Internet protocol address and generates a security score.

The location module (202) is connected to the Internet protocol address analysis module (201), determines in which area the Internet communication device (20) is located and may be a global positioning system, a time zone setting module, a language setting module or an Internet protocol address searching module.

The domain name system resolver database (203) is connected to the Internet protocol address analysis module (201) and comprises multiple domain name system resolvers of a variety of zones and a security score threshold.

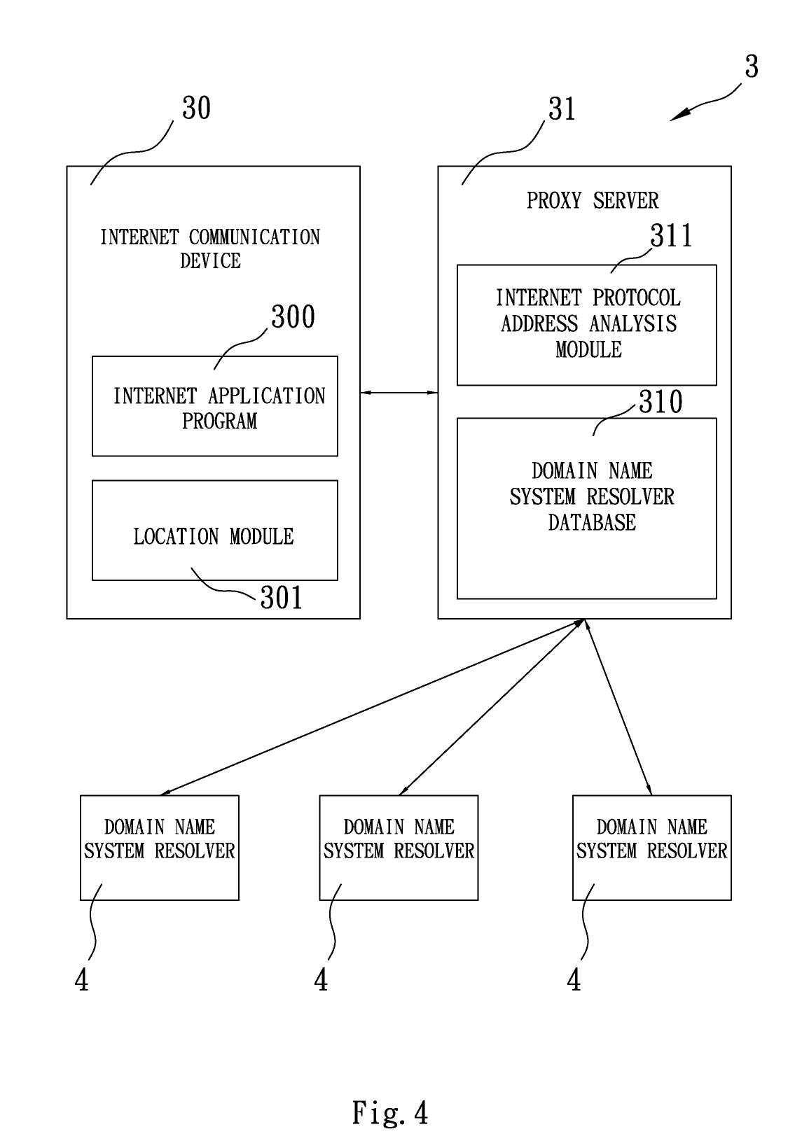

With reference to FIG. 4, a second embodiment of a system for preventing domain name system cache poisoning attacks (3) in accordance with the present invention quantifies security of an Internet protocol address and comprises an Internet communication device (30) and a proxy server (31).

The Internet communication device (30) comprises an Internet application program (300) and a location module (301). The Internet application program (300) connects to the Internet. The location module (301) determines in which area the Internet communication device (30) is located and may be a global positioning system, a time zone setting module, a language setting module or an Internet protocol address searching module.

The proxy server (31) comprises an Internet protocol address analysis module (310) and a domain name system resolver database (311). The Internet protocol address analysis module (310) selects a trustworthy Internet protocol address and generates a security score. The domain name system resolver database (311) comprises multiple domain name system resolvers of a variety of zones and a security score threshold.

Various changes can be made without departing from the broad spirit and scope of the invention.

What is claimed is:

1. A method for preventing domain name system cache poisoning attacks comprising steps of
inputting a domain name by an internet application program of an Internet communication device;
determining in which area the Internet communication device is located;
randomly selecting at least two domain name system resolvers of the area;
retrieving at least one Internet protocol addresses from the domain name system resolvers, and evaluating the Internet protocol addresses to generate at least one security score;
selecting a trustworthy Internet protocol address based on the security scores;
comparing the security score of the selected Internet protocol address with a predetermined security score threshold; and
sending the trustworthy Internet protocol address to the Internet application program of the Internet communication device when the security score is greater than the security score threshold.

2. The method as claimed in claim 1, wherein the step of determining in which area the Internet communication device is located is achieved by a global positioning system.

3. The method as claimed in claim 1, wherein the step of determining in which area the Internet communication device is located is achieved by a time zone setting module.

4. The method as claimed in claim 1, wherein the step of determining in which area the Internet communication device is located is achieved by a language setting module.

5. The method as claimed in claim 1, wherein the step of determining in which area the Internet communication device is located is achieved by an Internet protocol address searching module of the Internet communication device.

6. The method as claimed in claim 1, wherein the security scores of the retrieving step are derived from products of predetermined security level and an amount of the at least two domain name system resolvers.

7. The method as claimed in claim 6, wherein
execution of the retrieving at least one Internet protocol addresses action and execution of evaluating the Internet protocol addresses to generate at least one security scores action of the retrieving step are performed simultaneously, and
perform the step of selecting a trustworthy Internet protocol address based on the security scores before retrieving all of the Internet protocol addresses.

8. The method as claimed in claim 1 further comprising a step of sending the security score to the Internet application program of the Internet communication device; and the step of sending the security score to the Internet application program of the Internet communication device is executed after the step of sending the trustworthy Internet protocol address to the Internet application program of the Internet communication device.

9. The method as claimed in claim 1 is installed in domain name system client module of an operating system kernel.

10. The method as claimed in claim 1 is installed in an application program software.

11. A first embodiment of a system for preventing domain name system cache poisoning attacks comprising an Internet communication device, the Internet communication device comprising:
an Internet application program connecting to the Internet;
an Internet protocol address analysis module being connected to the Internet application program, selecting a trustworthy Internet protocol address and generating a security score;
a location module being connected to the Internet protocol address analysis module and determining in which area the Internet communication device is located; and
a domain name system resolver database being connected to the Internet protocol address analysis module and comprising multiple domain name system resolvers of a variety of zones and a security score threshold.

12. The system as claimed in claim 11, wherein the location module is a global positioning system.

13. The system as claimed in claim 11, wherein the location module is a time zone setting module.

14. The system as claimed in claim 11, wherein the location module is a language setting module.

15. The system as claimed in claim 11, wherein the location module is an Internet protocol address searching module.

16. A second embodiment of a system for preventing domain name system cache poisoning attacks comprising:
an Internet communication device comprising:
an Internet application program connecting to the Internet; and
a location module determining in which area of the Internet communication device is located; and
a proxy server comprising:
an Internet protocol address analysis module selecting a trustworthy Internet protocol address and generating a security score; and
a domain name system resolver database comprising multiple domain name system resolvers of a variety of zones and a security score threshold.

17. The system as claimed in claim 16, wherein the location module is a global positioning system.

18. The system as claimed in claim 16, wherein the location module is a time zone setting module.

19. The system as claimed in claim 16, wherein the location module is a language setting module.

20. The system as claimed in claim 16, wherein the location module is an Internet protocol address searching module.
